(19) United States
(12) Patent Application Publication
(10) Pub. No.: US 2017/0011065 A1
(43) Pub. Date: Jan. 12, 2017

(54) Methods and Systems for Establishing Geofences

(71) Applicant: Fractal Analytics Inc., San Mateo, CA (US)

(72) Inventors: Natwar Mall, Mumbai (IN); Sumith Balagangadharan, Thane (IN); Ankit Solanki, Mumbai (IN); Tirthankar Chakravarty, Mumbai (IN); Neha Singh, Gurgaon (IN)

(73) Assignee: Fractal Analytics Inc., San Mateo, CA (US)

(21) Appl. No.: 14/796,046

(22) Filed: Jul. 10, 2015

(51) Int. Cl. G06F 17/30; G06F 3/0482

(52) U.S. Cl. CPC G06F 17/30241; G06F 17/30554; G06F 17/3087; G06F 3/0482

(57) ABSTRACT

A plurality of geofences sharing a common geospatial characteristic can be established by using a graphical user interface (“GUI”) to receive a geofence command that expresses the common geospatial characteristic in natural language. The geofence command is parsed to identify proximity terms (which can be used to set the overall size of the geofence) and geospatial labels (which can be used to identify the “centers” of the geofences). The geospatial labels are used to search a geographic information system (“GIS”) for entities therein that match the geospatial labels. Geofences are established about these entities using the proximity term to determine the size thereof.

### BACKGROUND

The instant disclosure relates to mapping. In particular, the instant disclosure relates to the generation of geofences within a map of a geospatial region.

A “geofence” is a virtual barrier. That is, it forms a virtual perimeter around a real world location. As such, many geofences are defined by a location (e.g., a particular merchant) and a radius about that location (e.g., 100 meters).

It is known to use geofences to deliver messages, services, and the like to location-aware mobile devices. For example, when a location-aware mobile device enters a geofence established by a particular merchant (as measured, for example, using GPS, cellular tower triangulation, WiFi based positioning, and/or another suitable technique), the mobile device can display an offer to make a purchase from that merchant. As a specific example, Walmart uses geofences around its stores to deliver coupons to potential customers.

It can be cumbersome and time consuming, however, to establish geofences.

### BRIEF SUMMARY

Disclosed herein is a method of establishing a plurality of geofences sharing a common geospatial characteristic. The method includes the following steps: receiving a geofence command that expresses the common geospatial characteristic in natural language; parsing the geofence command to identify a proximity term and at least one geospatial label; executing a search of a geographic information system (“GIS”) using the identified at least one geospatial label, wherein the search of the GIS outputs one or more geospatial entities matching the at least one geospatial label; and establishing a geofence about each of the one or more geospatial entities using the proximity term. The at least one geospatial label can include one or more of an absolute geospatial label and a semantic geospatial label. The proximity term can include an absolute distance term and/or a relative distance term. The geofence command can be expressed using a syntax of <PROXIMITY TERM> <GEOSPATIAL LABEL>.

In embodiments, the method also includes: receiving geospatial data into the GIS; and transforming the geospatial data by applying a plurality of geospatial labels to the geospatial data. According to embodiments disclosed herein, receiving geospatial data into the GIS includes receiving OpenStreetMaps (“OSM”) XML data into the GIS.

In aspects of the disclosure, applying a plurality of geospatial labels to the geospatial data can include applying a plurality of semantic geospatial labels to the geospatial data. In other aspects of the disclosure, applying a plurality of geospatial labels to the geospatial data includes applying a plurality of absolute geospatial labels to the geospatial data. In yet further aspects of the disclosure, applying a plurality of absolute geospatial labels to the geospatial data includes: extracting a plurality of nodes from the GIS; extracting plurality of ways from the GIS; and using the extracted plurality of nodes and the extracted plurality of ways as the plurality of absolute geospatial labels.

Also disclosed herein is a method of establishing a plurality of geofences sharing a common geospatial characteristic, including: establishing a graphical user interface (“GUI”) including a command line and a map window; receiving, via the command line, a geofence command, the geofence command including at least one proximity term and at least one geospatial label; querying a geographic information system (“GIS”) using the at least one geospatial label; outputting, as a result of querying the GIS using the at least one geospatial label, one or more geospatial entities within the GIS matching the at least one geospatial label; establishing a geofence about each geospatial entity of the one or more geospatial entities using the at least one proximity term; and displaying the geofence about each geospatial entity within the map window of the GUI. The proximity term can include a relative distance term, and the method can also include defining an absolute distance associated with the relative distance term. The at least one geospatial label can include at least one semantic geospatial label and/or at least one absolute geospatial label.

It is contemplated herein that establishing a geofence about each geospatial entity of the one or more geospatial entities using the at least one proximity term can include: identifying a centroid of the geospatial entity of the one or more geospatial entities; and establishing a circular geofence centered at the centroid and having a radius corresponding to the at least one proximity term.

In another aspect of the instant disclosure, a system for establishing a plurality of geofences sharing a common geospatial characteristic includes: a graphical user interface (“GUI”) processor configured to establish a GUI including a command line and a map window; and a geofence command processor configured: to receive, via the command line, a geofence command, wherein the geofence command expresses the common geospatial characteristic; to parse the geofence command to identify a proximity term and at least one geospatial label; to query a geographic information system (“GIS”) using the at least one geospatial label to identify one or more geospatial entities within the GIS that match the at least one geospatial label; and to establish a geofence extending a distance corresponding to the proximity term from each geospatial entity of the identified one or more geospatial entities. The geofence command processor can include a natural language processing module configured to parse the geofence command to identify the proximity term and the at least one geospatial label. The geofence command processor can also be configured to display, in the map window, a map of a geographical region overlaid with a graphical representation of the geofence established for each geospatial entity of the identified one or more geospatial entities.

In embodiments, the system can also include a GIS data processor configured to: receive geospatial data; and apply a plurality of geospatial labels to the received geospatial data. For example, the GIS data processor can be configured to apply a plurality of geospatial labels to the received geospatial data by extracting metadata from the received geospatial data and assigning a plurality of semantic geospatial labels to the received geospatial data using the extracted metadata.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a screen shot of a representative graphical user interface (“GUI”) as may be utilized according to the teachings herein.

FIG. 2 is a flowchart of representative steps that may be carried out in the establishment of geofences according to the instant disclosure.

FIGS. 3 through 5 are screen shots of the representative GUI of FIG. 1 illustrating the establishment of geofences according to embodiments disclosed herein.

### DETAILED DESCRIPTION

The present disclosure provides computer systems and computer-implemented methods useful to generate a plurality of geofences sharing a common geospatial characteristic. For purposes of illustration, the teachings herein will be explained with reference to the simultaneous creation of a large number of circular geofences. It should be understood, however, that the instant teachings can likewise be practiced to good advantage in other contexts without departing from the spirit and scope of the present disclosure.

The methods disclosed herein can be carried out by one or more processors incorporated into one or more computing devices (e.g., desktop computers, laptop computers, server computers, handheld computer, and the like). Moreover, as used herein, the term “processor” refers to not only a single central processing unit (“CPU”), but also to a plurality of CPUs, commonly referred to as a parallel processing environment. It should also be understood that the methods disclosed herein can be hardware, software, and/or firmware implemented.

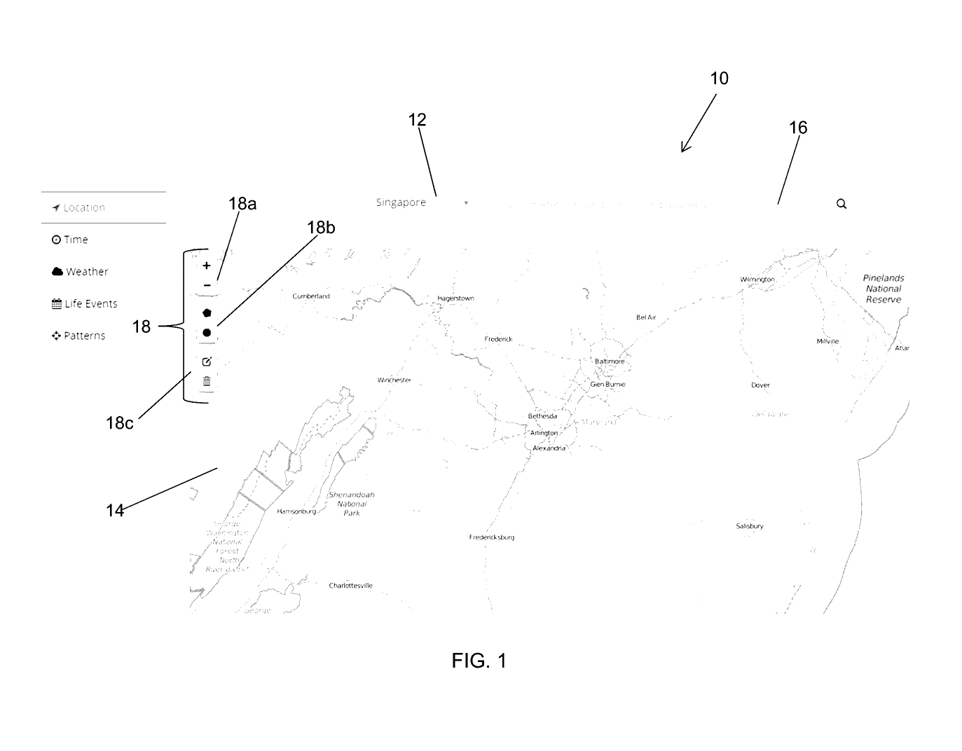

FIG. 1 is a screen shot of a representative graphical user interface (“GUI”) 10 as may be used for the establishment of geofences according to the teachings herein. GUI 10 includes a location drop-down box 12, a map window 14, and a command line 16. Map window 14 can further include controls 18 (e.g., zoom controls 18a, draw controls 18b, and layer controls 18c). The ordinarily skilled artisan will appreciate, however, that FIG. 1 is representative, and that the design of GUI 10 design in a particular embodiment could differ without departing from the spirit and scope of the instant disclosure.

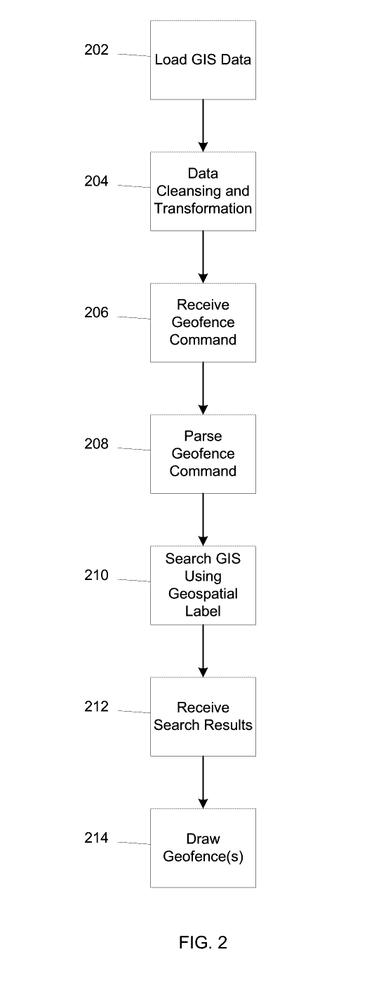

FIG. 2 is a flowchart 200 of representative steps that can be carried out in a method of establishing a plurality of geofences according to aspects disclosed herein. Block 202 is a data loading or data generating step. In particular, in step 202, a geographic information system (“GIS”) is established. A GIS “is a computer system for capturing, storing, checking, and displaying data related to positions on Earth's surface.” http://education.nationalgeographic.com/education/encyclopedia/geographic-information-system-gis.?ar_a=1 (retrieved Jun. 29, 2015). The GIS can be established by extracting geospatial data from a data source, such as OpenStreetMap (“OSM”), which data is available in OSM XML format. The person of ordinary skill in the art, however, will understand how to adapt the teachings herein to any GIS.

In some embodiments, additional data cleansing and/or transformation may be performed in block 204. For example, the data may be transformed by applying a plurality of geospatial labels to the geospatial data. For purposes of this disclosure, there are two types of geospatial labels. “Semantic geospatial labels” are improper nouns that generally describe an entity within the GIS, such as “park,” “hospital,” “school,” or “company.” “Absolute geospatial labels” are proper nouns that specifically describe an entity within the GIS, such as “Central Park,” “Columbia University,” or “Yankee Stadium.” An place or location may have many semantic geospatial labels, but will typically have only one absolute geospatial label corresponding to its specific name.

Much of the geospatial data within the GIS will have an absolute geospatial label as well as at least one semantic geospatial label. It is contemplated, however, that a particular entry in the GIS may have only a semantic geospatial label or only an absolute geospatial label.

Those of ordinary skill in the art will understand that geospatial data in the OSM XML format includes metadata that can be used to assign semantic geospatial labels. Similarly, nodes and ways can be extracted from the OSM XML formatted geospatial data and used as absolute geospatial labels.

In sum, however, the result of blocks 202 and 204 is the establishment of a GIS containing geospatial data associated with geospatial labels (e.g., absolute and/or semantic geospatial labels). These geospatial labels can then be leveraged, as discussed below, in order to establish a plurality of geofences sharing a common geospatial characteristic without having to establish each geofence individually and independently.

In block 206, therefore, a geofence command is received, for example via command line 16. Generally speaking, the geofence command will include a geospatial label (e.g., a semantic geospatial label and/or an absolute geospatial label) and a proximity term (e.g., a term that describes the “size” of the geofence, typically as measured from a geospatial entity in the GIS).

In embodiments, the geofence command can be expressed in natural language. One suitable natural language syntax for the geofence command is <PROXIMITY TERM> <GEOSPATIAL LABEL>.

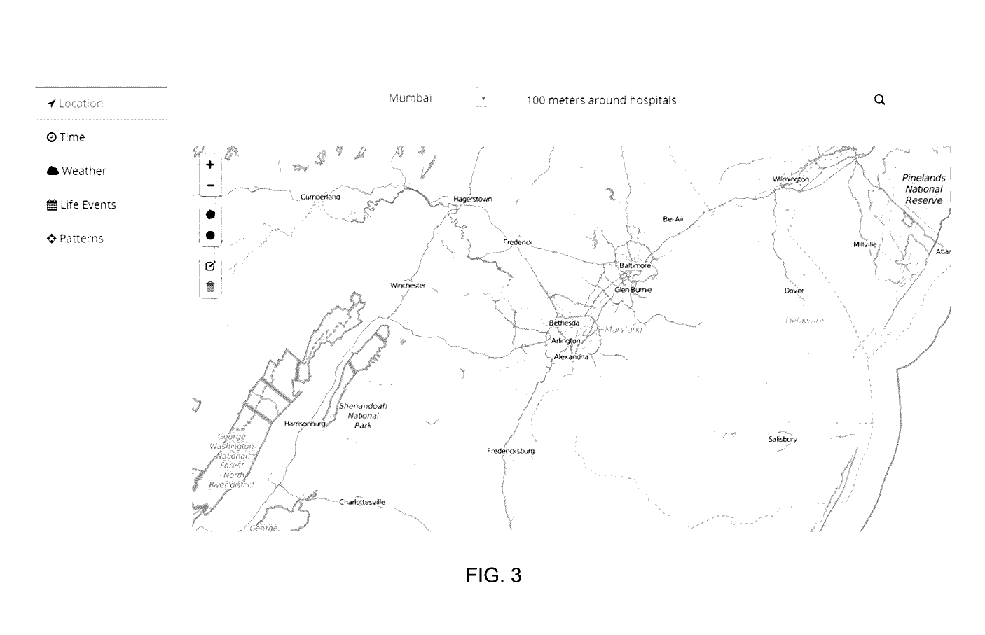

FIG. 3 illustrates the natural language geofence command “100 meters around hospitals,” executed (as seen in location drop-down box 12) in Mumbai, India. In block 208, the geofence command is parsed to identify the proximity term (e.g., “100 meters”) and geospatial label (e.g., “hospital”) contained therein.

In block 210, the GIS is searched using the identified geospatial label(s). The output of the search in block 210, shown in block 212, is one or more geospatial entities (e.g., in GeoJSON format) contained within the GIS that match the identified geospatial label(s) (that is, they possess the semantic geospatial label “hospital”).

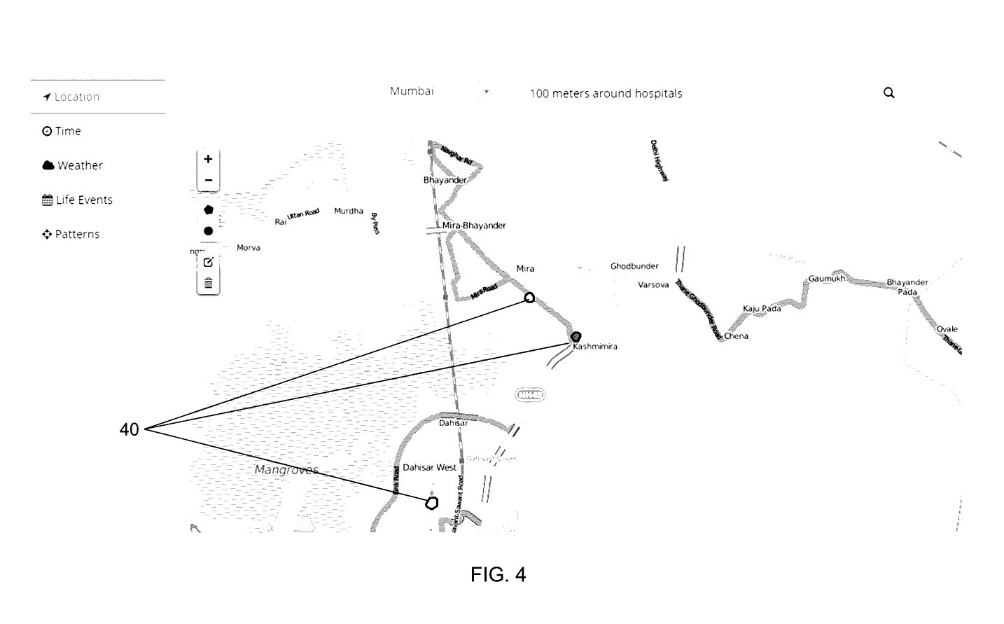

Geofences are drawn in block 214. In particular, the proximity term (“100 meters”) is used to establish the extent to which the geofence extends outwardly from the geospatial entities output in block 212. Where the output geospatial entity is defined as a point or node (which can be the case for certain buildings, for example), the result will be a circular geofence having its center at the coordinates of the geospatial entity and a radius corresponding to the proximity term. This is illustrated to good advantage in FIG. 4, which is the output of the geofence command shown in FIG. 3. In particular, FIG. 4 shows three circular geofences 40, each of which extends outwardly 100 meters from a hospital within Mumbai.

It is contemplated, however, that the geofence can have a different and/or more irregular shape, for example, where the output geospatial entity is defined as a line (which can be the case for railways and roadways, for example), as a polygon (which can be the case for parks, for example), as multiple points (which can be the case for a large complex of related buildings, for example), or the like.

It is also contemplated that non-point geospatial entities can be redefined for purposes of establishing the geofence. For example, when establishing a geofence about a polygonal geospatial entity, the centroid of the polygon can be used as the center of a circular geofence.

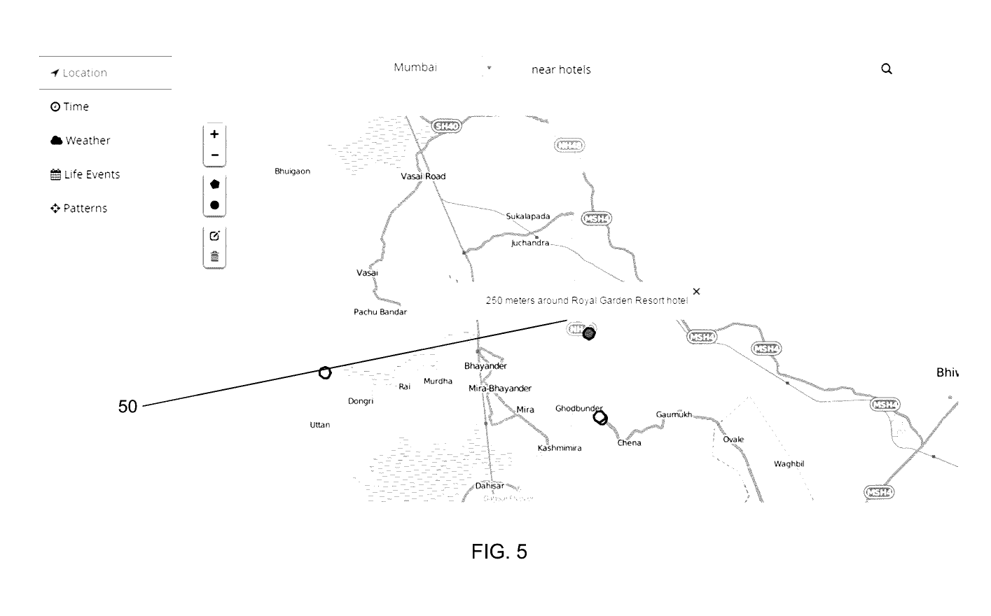

The proximity term described above, “100 meters,” is referred to herein as an “absolute distance term.” That is, it specifies a precise distance from the geospatial entity. It is also within the scope of the instant disclosure to use a “relative distance term,” such as “near.” It should be understood that relative distance terms will be associated with absolute distances in order to draw the geofences, though this association may be transparent to the end user. For example, as shown in FIG. 5, the term “near” is interpreted as “250 meters around” (as indicated in pop-up box 50). Of course, the association can also be visible to and/or customizable by the end user.

Although several embodiments have been described above with a certain degree of particularity, those skilled in the art could make numerous alterations to the disclosed embodiments without departing from the spirit or scope of this invention.

For example, although the embodiments described above utilize geofence commands including a single proximity term and a single geospatial label, more complex geofence commands are contemplated. For example, a geofence command can include multiple geospatial labels and proximity terms (e.g., “100 meters from hospitals along an interstate”). Geofence commands can also include Boolean logic (e.g., “100 meters from hospitals AND 50 meters from airports”). Geospatial labels can also include multiple words (e.g., “private universities”).

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of establishing a plurality of geofences sharing a common geospatial characteristic, the method comprising:
receiving a geofence command that expresses the common geospatial characteristic in natural language;
parsing the geofence command to identify a proximity term and at least one geospatial label;
executing a search of a geographic information system (“GIS”) using the identified at least one geospatial label, wherein the search of the GIS outputs one or more geospatial entities matching the at least one geospatial label; and
establishing a geofence about each of the one or more geospatial entities using the proximity term.

2. The method according to claim 1, wherein the at least one geospatial label comprises one or more of an absolute geospatial label and a semantic geospatial label.

3. The method according to claim 1, wherein the proximity term comprises an absolute distance term.

4. The method according to claim 1, wherein the proximity term comprises a relative distance term.

5. The method according to claim 1, wherein the geofence command is expressed using a syntax of <PROXIMITY TERM> <GEOSPATIAL LABEL>.

6. The method according to claim 1, further comprising:
receiving geospatial data into the GIS; and
transforming the geospatial data by applying a plurality of geospatial labels to the geospatial data.

7. The method according to claim 6, wherein applying a plurality of geospatial labels to the geospatial data comprises applying a plurality of semantic geospatial labels to the geospatial data.

8. The method according to claim 6, wherein applying a plurality of geospatial labels to the geospatial data comprises applying a plurality of absolute geospatial labels to the geospatial data.

9. The method according to claim 8, wherein applying a plurality of absolute geospatial labels to the geospatial data comprises:
extracting a plurality of nodes from the GIS;
extracting plurality of ways from the GIS; and
using the extracted plurality of nodes and the extracted plurality of ways as the plurality of absolute geospatial labels.

10. The method according to claim 6, wherein receiving geospatial data into the GIS comprises receiving OpenStreetMaps (“OSM”) XML data into the GIS.

11. A method of establishing a plurality of geofences sharing a common geospatial characteristic, the method comprising:
establishing a graphical user interface (“GUI”) including a command line and a map window;
receiving, via the command line, a geofence command, the geofence command including at least one proximity term and at least one geospatial label;
querying a geographic information system (“GIS”) using the at least one geospatial label;
outputting, as a result of querying the GIS using the at least one geospatial label, one or more geospatial entities within the GIS matching the at least one geospatial label;
establishing a geofence about each geospatial entity of the one or more geospatial entities using the at least one proximity term; and
displaying the geofence about each geospatial entity within the map window of the GUI.

12. The method according to claim 11, wherein the proximity term comprises a relative distance term, and wherein the method further comprises defining an absolute distance associated with the relative distance term.

13. The method according to claim 11, wherein the at least one geospatial label comprises at least one semantic geospatial label.

14. The method according to claim 11, wherein the at least one geospatial label comprises at least one absolute geospatial label.

15. The method according to claim 11, wherein establishing a geofence about each geospatial entity of the one or more geospatial entities using the at least one proximity term comprises:
identifying a centroid of the geospatial entity of the one or more geospatial entities; and
establishing a circular geofence centered at the centroid and having a radius corresponding to the at least one proximity term.

16. A system for establishing a plurality of geofences sharing a common geospatial characteristic, comprising:
a graphical user interface (“GUI”) processor configured to establish a GUI including a command line and a map window;
a geofence command processor configured:
to receive, via the command line, a geofence command, wherein the geofence command expresses the common geospatial characteristic;
to parse the geofence command to identify a proximity term and at least one geospatial label;
to query a geographic information system (“GIS”) using the at least one geospatial label to identify one or more geospatial entities within the GIS that match the at least one geospatial label; and
to establish a geofence extending a distance corresponding to the proximity term from each geospatial entity of the identified one or more geospatial entities.

17. The system according to claim 16, wherein the geofence command processor comprises a natural language processing module, and wherein the natural language processing module is configured to parse the geofence command to identify the proximity term and the at least one geospatial label.

18. The system according to claim 16, wherein the geofence command processor is further configured to display, in the map window, a map of a geographical region overlaid with a graphical representation of the geofence established for each geospatial entity of the identified one or more geospatial entities.

19. The system according to claim 16, further comprising a GIS data processor configured to:
receive geospatial data; and
apply a plurality of geospatial labels to the received geospatial data.

20. The system according to claim 19, wherein the GIS data processor is configured to apply a plurality of geospatial labels to the received geospatial data by extracting metadata from the received geospatial data and assigning a plurality of semantic geospatial labels to the received geospatial data using the extracted metadata.
